(19) United States
(12) Patent Application Publication
(10) Pub. No.: US 2011/0045758 A1
(43) Pub. Date: Feb. 24, 2011

(54) VENTILATION NOZZLE

(76) Inventor: Ulf-Lothar BASTIAN, Pfalzgrafenweiler (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/855,012

(22) Filed: Aug. 12, 2010

(30) Foreign Application Priority Data
Aug. 20, 2009 (DE) 102009038260.7

(51) Int. Cl. B60H 1/34

(52) U.S. Cl. 454/152

(57) ABSTRACT

A ventilation nozzle for the passenger compartment of a motor vehicle, having an air-guiding device, for example a spoiler. In order to be able to demould the air-guiding device after its production by injection-moulding, the air-guiding device may be pivotally connected by way of a film hinge.

### CROSS-REFERENCE TO RELATED APPLICATION

The present application claims priority under 35 USC §119 to German Patent Application No. 10 2009 038 260.7 filed Aug. 20, 2009, the entire disclosure of which is incorporated herein by reference.

### TECHNICAL FIELD OF THE INVENTION

The invention relates to a ventilation nozzle for supplying air to the passenger compartment of a vehicle.

### DESCRIPTION OF THE RELATED ART

Such ventilation nozzles are known, for example, from motor vehicles. They are usually tubular with a round, not necessarily circular, or angular cross-section and can have fixed or pivotable vanes for directing a current of air through the ventilation nozzle.

The patent application GB 2 303 205 A discloses a ventilation nozzle having a number of vanes parallel to one another and rigidly arranged in a frame which is pivotally mounted in the ventilation nozzle. When the frame is pivoted to a substantial extent, gaps form between the frame and the ventilation nozzle. In order to avoid passage of air through those gaps, the mentioned patent application provides spoilers which project inwards from the ventilation nozzle and cover the gaps between the frame having the vanes, when it is pivoted to a substantial extent, and the ventilation nozzle. The spoilers form undercuts which prevent the ventilation nozzle from being demoulded from a cavity of a mould after production of the ventilation nozzle by primary shaping. The spoilers must therefore be produced separately and mounted in the ventilation nozzle.

### SUMMARY OF THE INVENTION

The problem addressed by the invention is to propose a ventilation nozzle having a spoiler or, generally, an air-guiding device which forms an undercut but is nevertheless demouldable from the cavity of a primary-shaping mould.

That problem is solved according to the invention as described herein. The ventilation nozzle according to the invention has an air-guiding device which forms an undercut and is constructed so as to be movable, so that it is able to move out of the position forming the undercut into a non-undercutting position and/or vice versa. The invention has the advantage that the ventilation nozzle is simpler and more economical to produce; irrespective of the way in which the invention is implemented, the production of the air-guiding device as a separate component and its mounting in the air-guiding nozzle, for example, is dispensed with.

The air-guiding device can be a one-piece component of the ventilation nozzle and can be produced therewith in one operation by primary shaping, for example injection-moulding. One construction in accordance with the invention provides that the air-guiding device is formed on a holder which is already inserted or is to be inserted into the ventilation nozzle. The holder can be a frame which is necessary in any case and which has, for example, vanes of the ventilation nozzle. The list is exemplary and not exhaustive.

A development of the invention provides that the ventilation nozzle holds the air-guiding device in the undercut position when the holder on which the air-guiding device is formed has been inserted into the ventilation nozzle. For example, the ventilation nozzle presses the air-guiding device inwards into the ventilation nozzle into its air-guiding functional position in which is simultaneously also forms the undercut.

It is possible for the air-guiding device to be made from a different material from that of the ventilation nozzle and/or to be resilient. For example, it is possible within the scope of the invention for the air-guiding device to be made resiliently deformable so that although the air-guiding device forms an undercut, the ventilation nozzle can be demoulded. On demoulding and as a result thereof, the air-guiding device is pressed to the side, for example by the mould, so that the ventilation nozzle can be demoulded. One construction of the invention provides that the air-guiding device is pivotable; the air-guiding device is able to pivot out of the functional position forming the undercut into the non-undercutting position in which it is demouldable, and/or vice versa.

In a development of the invention, pivotability of the air-guiding device is provided by a film hinge. A film hinge is a straight, linear region which has a thinner wall than the adjoining regions and is so thin-walled that it allows pivotability like a hinge. Typically, one- or two-sided grooving is used for forming a film hinge. Other constructions are not excluded.

### BRIEF DESCRIPTION OF THE DRAWINGS

The invention will be described in greater detail below with reference to an exemplary embodiment shown in the drawing, wherein

FIG. 1 is a longitudinal section through a ventilation nozzle according to the invention; and

FIG. 2 shows a detail in accordance with arrow II in FIG. 1.

### DETAILED DESCRIPTION OF THE INVENTION

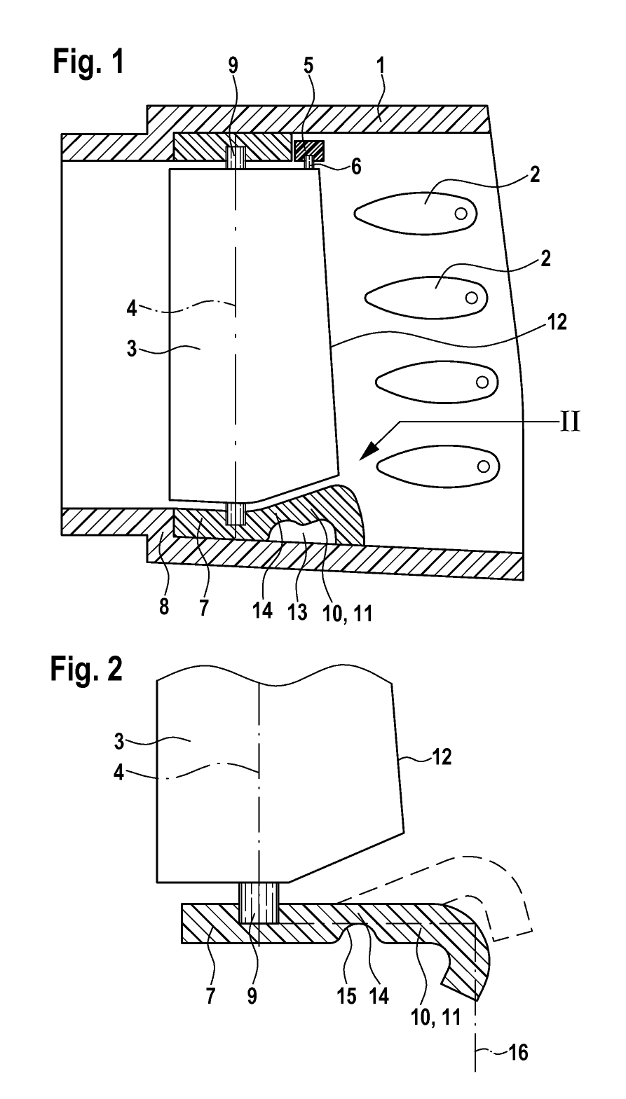

The ventilation nozzle 1 according to the invention shown in FIG. 1 is provided for supplying air to the passenger compartment of a motor vehicle (not shown). The ventilation nozzle 1 has a rectangular tubular shape; it widens out slightly in the direction of throughflow (from left to right in FIG. 1). In an outlet opening, vanes 2 are arranged horizontally and parallel to one another, the vanes being pivotable together about horizontal axes. In a central region of the ventilation nozzle 1, that is to say upstream of the horizontal vanes 2 in the direction of throughflow, vanes 3 are arranged vertically and parallel to one another, the vanes being pivotable together about vertical axes 4. For common pivoting there is arranged in the ventilation nozzle 1, transversely and close to the edge, a bar 5 in which pins 6 of the vanes 3 engage. Movement of the bar 5 transversely with respect to the ventilation nozzle 1 causes the vanes 3 to pivot.

The vertical vanes 3 are held and pivotally mounted in a frame 7. The frame 7 is rectangular like the ventilation nozzle 1; its outer contour corresponds to the inner contour of the ventilation nozzle 1. The frame 7 rests against a peripheral step 8 of the ventilation nozzle 1. The vanes 3 have journals 9 which engage in bearing holes in the frame 7 so that the vanes 3 are pivotally mounted in the frame 7. The frame 7 has an air-guiding device 10 in the form of a spoiler 11 which is arranged at the lower side of the frame 7, downstream of the journals 9 in the direction of flow, and which, seen in the direction of flow, first rises into the ventilation nozzle 1 and then, after the rear edge 12 of the vertical vanes 3, drops away outwards to the wall of the ventilation nozzle 1. The spoiler 11, which forms the air-guiding device 10, therefore extends a short way into the ventilation nozzle 1. On its outer or lower side, the spoiler 11 has a cavity 13 between itself and the wall of the ventilation nozzle 1. The shape and arrangement of the spoiler 11 or, generally, the air-guiding device 10 are not important for the invention; the air-guiding device 10 can have a different shape and/or be arranged at a different location. As a result of its rising into the ventilation nozzle 1 and as a result of the cavity 13 on the outer or lower side, the air-guiding device 10 forms an undercut which prevents the frame 7 from being demoulded from a mould after an injection-moulding operation or which would require a complex mould having at least one slide to enable the frame 7 to be demoulded. The spoiler 11, which forms the air-guiding device 10, is therefore connected to the frame 7 so as to be movable; it is produced together with and in one piece with the frame 7 in a position that allows the frame 7 to be demoulded, and on insertion into the ventilation nozzle 1 moves into a functional position in which it rises into the interior of the ventilation nozzle 1 in order to guide the throughflow of air through the ventilation nozzle 1. In the exemplary embodiment, the spoiler 11 is pivotally connected to the frame 7 by means of a film hinge 14. The film hinge 14 is formed by a straight channel 15 which runs transversely with respect to the ventilation nozzle 1, that is to say in the longitudinal direction of the side of the frame 7 on which the spoiler 11 is arranged. The channel 15 reduces the wall thickness of the frame 7 so that the spoiler 11 is able to pivot. In FIG. 2, the position of the spoiler 11 after demoulding is shown by solid lines and the position in which it has been pivoted upwards, i.e. inwards, into the interior of the ventilation nozzle 1 is shown by dotted lines. On insertion into the ventilation nozzle 1, the spoiler 11 is pivoted inwards into the functional position and held in that functional position by the wall of the ventilation nozzle 1.

The production of the vertical vanes 3 and of the frame 7 is effected in two steps in a so-called in-mould assembly operation in a mould (not shown). In a first step, the vanes 3 are injection-moulded in the mould. In the mould they have their later spatial arrangement, that is to say in parallel one next to the other. In addition to cavities for the vanes 3, the mould (not shown) has a cavity for the frame 7 including its spoiler 11. In the first step, during injection-moulding of the vanes 3 the cavity for the frame 7 is filled with a core. After the injection-moulding of the vanes 3, the mould is opened, the core is removed and the mould closed again. The vanes 3 remain in the mould and in a second step the frame 7 is injection-moulded. The mould is then opened again and the frame 7 with the vanes 3 demoulded. The spoiler 11, as already mentioned, occupies the production position shown by solid lines in FIG. 2, which allows demoulding from the mould. In the production position, the spoiler 11 extends in the same plane as the side of the frame 7 on which it is arranged and finally curves outwards in a hook shape. A parting plane 16 of the mould is located at the place where the vanes 3 are at their thickest; in the exemplary embodiment that is the plane in which the pivot axes 4 of the vanes 3 are located. On the side of the frame 7 on which the spoiler 11 is located, the parting plane 16 of the mould is bent at an angle, as shown by the dash-dotted line in FIG. 2, that is to say it runs in the same plane as that side of the frame 7 and, at the point where the spoiler 11 curves outwards in a hook shape in cross-section, is bent outwards again. Although the channel 15, which is present for forming the film hinge 14, forms an undercut, the channel 15 is sufficiently flat and rounded for the frame 7 with the vanes 3 nevertheless to be demouldable.

As already mentioned, on insertion of the frame 7 into the ventilation nozzle 1 the wall of the ventilation nozzle 1 pivots the spoiler 11 inwards into its functional position. The frame 7 forms a holder for the spoiler 11 which forms the air-guiding device 10 of the ventilation nozzle 1.

Further features of the invention can be found in the description of preferred embodiments of the invention in connection with the claims and the drawings. The single features can be realised alone or several together in embodiments of the invention.

1 vane

2 vane

3 pivot axis

4 bar

5 pin

6 frame

7 step

8 journal

9 air-guiding device

10 spoiler

11 rear edge

12 cavity

13 film hinge

14 channel

15 parting plane

1. A ventilation nozzle for supplying air to a passenger compartment of a vehicle, there being arranged in the ventilation nozzle an air-guiding device which forms an undercut, wherein the air-guiding device is constructed so as to be movable, so that it is able to move into a non-undercutting position.

2. The ventilation nozzle according to claim 1, wherein the air-guiding device is formed on a holder inserted into the ventilation nozzle.

3. The ventilation nozzle according to claim 2, wherein the ventilation nozzle holds the air-guiding device in the undercutting position.

4. The ventilation nozzle according to claim 1, wherein the air-guiding device is pivotable out of the undercut position into the non-undercutting position and vice versa.

5. The ventilation nozzle according to claim 4, wherein the air-guiding device has a film hinge.
